(19) United States
(12) Patent Application Publication
(10) Pub. No.: US 2021/0185766 A1
(43) Pub. Date: Jun. 17, 2021

(54) Heating Module

(71) Applicant: TDK Electronics AG, Munich (DE)

(72) Inventors: Michael Krenn, Dobl-Zwaring (AT); Iwan Hadi, Frauental (AT); Torben Halfer, Graz (AT); Huinan Xie, Zhuhai (CN)

(21) Appl. No.: 17/056,952

(22) PCT Filed: May 24, 2019
(86) PCT No.: PCT/EP2019/063474

§ 371 Date: Nov. 19, 2020

(30) Foreign Application Priority Data
Jun. 1, 2018 (CN) 201810555327.3
Jun. 1, 2018 (CN) 201820842027.9

(51) Int. Cl. H05B 3/14; H05B 3/24

(52) U.S. Cl. CPC H05B 3/141; H05B 2203/021; H05B 2203/02; H05B 3/24

(57) ABSTRACT

A heating module is disclosed. In an embodiment a heating module includes at least one positive temperature coefficient (PTC) element configured to operate at an operating point between 120° C. and 300° C. inclusive.

This patent application is a national phase filing under section 371 of PCT/EP2019/063474, filed May 24, 2019, which claims the priority of Chinese patent application 201820842027.9, filed Jun. 1, 2018, and Chinese patent application 201810555327.3, filed Jun. 1, 2018, each of which is incorporated herein by reference in its entirety.

### TECHNICAL FIELD

The present invention relates to a heating module.

### BACKGROUND

Very high temperatures can sometimes be produced in heating modules. Said very high temperatures can be associated with safety risks under certain circumstances. For example, a malfunction of a heating module can lead to overheating. In addition, use of a heating module in conjunction with certain chemicals, for example adhesives, should be avoided in order to not trigger any undesired chemical reactions.

### SUMMARY

Embodiments provide an improved heating module, for example, a heating module in which the abovementioned safety risks can be at least reduced.

Embodiments provide a heating module for a vaporization device, which heating module has at least one PTC element (PTC=positive temperature coefficient).

The PTC element is distinguished in that it has a positive temperature coefficient and conducts an electric current more effectively at low temperatures than at high temperatures. The PTC element can comprise a ceramic with a positive temperature coefficient. In particular, the PTC element can consist of the ceramic with the positive temperature coefficient.

The positive temperature coefficient of the PTC element can contribute to preventing overheating of the heating module as a result of a malfunction of the heating module or of a component which is connected to the heating module. For example, the malfunction could lead to an excessively high power being applied to the heating module and therefore a high current flowing across the heating module. The PTC element would heat up very rapidly in this case, so that its resistance increases sharply. As a result of this, the current intensity decreases, so that overheating and therefore destruction of the heating module can be prevented. The PTC element can therefore contribute to safe use of the heating module.

The heating module can be configured to generate heat when it is actuated by an actuation module or an actuation electronics system. The actuation module or the actuation electronics system can apply a voltage to the heating module in this case.

The heating module can be suitable, in particular, for use in a vaporization device. In this case, the heating module can be configured to generate heat which is used to vaporize a substance. The substance may be a liquid or a solid. The heating module can be configured, for example, to give off the heat generated by it indirectly or directly to the substance. For example, the heating module can have a surface at which the generated heat is given off.

The PTC element can comprise a ceramic material which has a non-linear resistance profile. For example, the ceramic material can have a temperature/resistance characteristic in which the resistance exhibits a very sharp rise when a characteristic temperature is exceeded. In this case, the characteristic temperature can define an operating point of the heating module.

The PTC element can form, in particular, a self-regulating heating element. The self-regulating heating element can effectively prevent overheating as a result of a malfunction.

The PTC element can be fastened by a clamping connection. A clamping connection can be made without using further materials in the process. In particular, an adhesive can be dispensed with in the case of a clamping connection. Owing to the adhesive being dispensed with, it is possible to preclude chemical reactions being triggered in the adhesive by the heat which is generated by the heating module. Accordingly, by way of clamping the PTC element in the heating module, it is possible to preclude a user of the heating module being exposed to harmful substances which are generated by chemical reactions, for example with an adhesive.

The heating module can further have a metal housing and a clamping contact. The PTC element can be clamped in between the metal housing and the clamping contact. In this case, the PTC element can be configured to heat the metal housing. For example, a voltage which leads to heating of the PTC element can be applied between the housing and the clamping contact. In particular, the PTC element can be heated as a result of the voltage which is applied between the metal housing and the clamping contact. The PTC element can be configured to give off the heat which is generated in the process to the housing.

The clamping contact of the PTC element with the housing can ensure that the PTC element rests on the housing over a large surface area and transfers the heat to the housing without loss as far as possible. There is preferably no air gap between the PTC element and the housing. In some embodiments, there can be a small air gap between the PTC element and the housing. The absence of an air gap or at least the slight extent of the air gap can contribute to good heat transfer from the heating module to the housing.

Since the housing contains a metal material, it can serve as an electrode for applying a voltage to the PTC element. Therefore, a heating module can be constructed with as small a number of components as possible.

The PTC element can be arranged on an outer side of the metal housing. The metal housing can be sleevelike. The metal housing can have an hexagonal outer side. In this case, the housing is viewed in cross section perpendicularly to an axis of the sleeve. The metal housing can have a round inner side.

The heating module can have a plurality of PTC elements. In one embodiment, the heating module has six PTC elements. The heating module can have any desired number of PTC elements. Heat can be generated more uniformly owing to the use of a plurality of PTC elements. In particular, different regions of the housing can be heated at the same time in this way. Furthermore, a relatively large quantity of heat can be generated owing to the use of a plurality of PTC elements. Therefore, the substance to be vaporized can therefore be heated more rapidly and more uniformly in the vaporization device owing to the use of a plurality of PTC elements.

Each of the PTC elements can be clamped in between the metal housing and the clamping contact. Therefore, simple and at the same time reliable fastening of the PTC elements can be produced. In particular, adhesive can be dispensed with in the case of this fastening, so that health hazards resulting from heating of adhesive can be precluded.

The clamping contact can have a plurality of arms and each of the PTC elements can be arranged between the metal housing and one of the arms of the clamping contact. In particular, each of the PTC elements can be clamped in between an arm and the housing. Since the PTC elements can all be fastened in the same way, it is therefore possible to ensure that they heat the housing in the same way and regions at different temperatures do not form in the housing.

The PTC elements can be arranged symmetrically in relation to an axis of the metal housing. The symmetrical arrangement can render it possible for a large portion of the surface of the housing to be covered by PTC elements and therefore for the housing to be able to be rapidly heated.

Further embodiments provide a vaporization device which has the above-described heating module and an actuation electronics system which is configured to apply a voltage to the PTC element. Owing to the application of the voltage, the heating module is heated and can give off heat to a substance to be vaporized, which substance can vaporize as a result.

### BRIEF DESCRIPTION OF THE DRAWINGS

Preferred exemplary embodiments of the present invention will be explained below with reference to the figures.

FIG. 1 shows a heating module for a vaporization device in cross section;

FIGS. 2 and 3 show perspective views of the heating module;

FIG. 4 shows pails of the heating module before assembly of the heating module;

FIGS. 5 to 7 show the assembly of the heating module;

FIG. 8 shows results of a simulation of the behavior of the heating module; and

FIG. 9 shows the measurement results of a prototype of the heating module.

### DETAILED DESCRIPTION OF ILLUSTRATIVE EMBODIMENTS

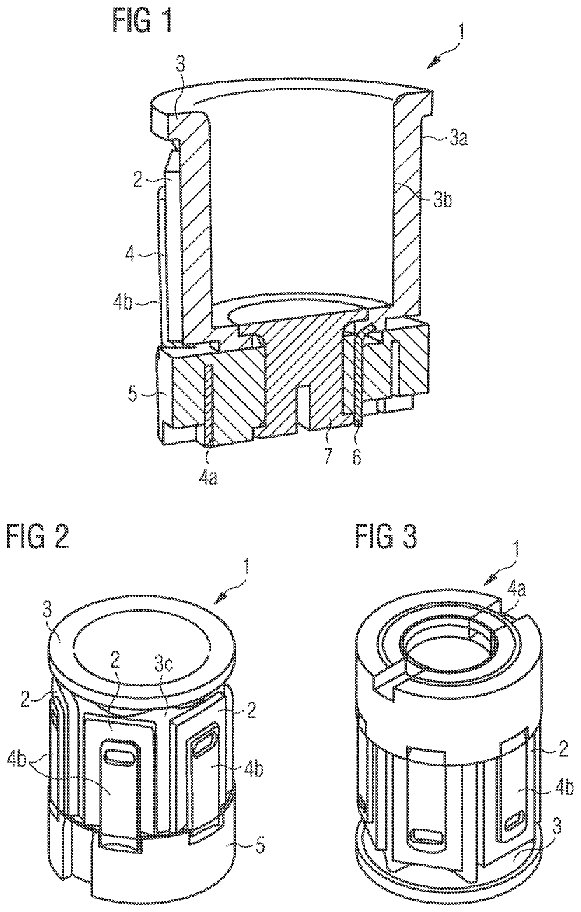

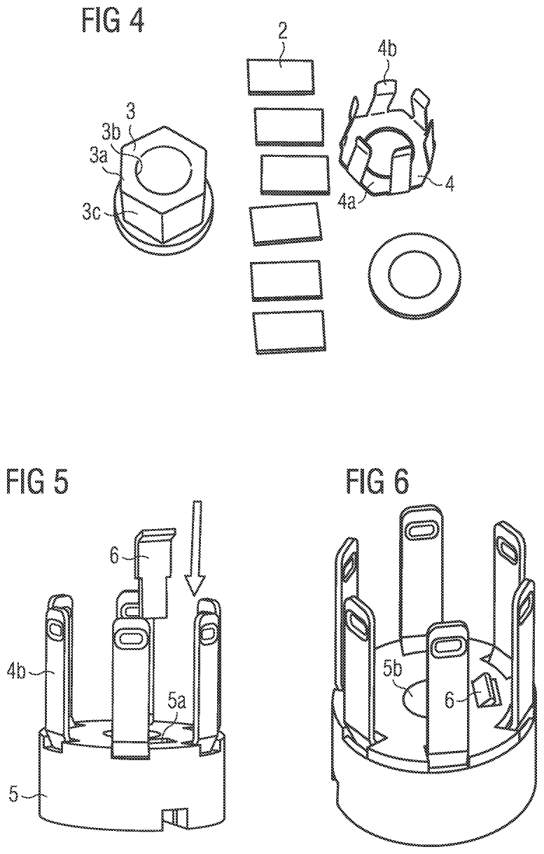

FIG. 1 shows a heating module 1 for a vaporization device in cross section. FIGS. 2 and 3 show perspective views of the heating module 1. FIG. 4 shows parts of the heating module 1 before assembly of the heating module.

The heating module 1 has a plurality of PTC elements 2 (PTC=positive temperature coefficient), a housing 3 and a clamping contact 4. The PTC elements 2 serve to heat the housing 3. Each of the PTC elements 2 is clamped in between an outer side 3a of the housing 3 and the clamping contact 4. In this case, the housing 3 and the clamping contact 4 act as electrodes via which a voltage is applied to the PTC elements 2.

The heating module 1 shown here has six PTC elements 2. In alternative embodiments, the heating module 1 has a different number of PTC elements 2. In one embodiment, the heating module 1 has only one single PTC element 2.

If a voltage is applied between the clamping contact 4 and the housing 3, a current flows across the PTC elements 2. The PTC elements 2 are heated by the current flow. The PTC elements 2 give off the heat which is generated by them to the housing 3.

The PTC elements 2 comprise a ceramic material with a non-linear resistance/temperature characteristic. The resistance of the PTC elements 2 rises considerably as the temperature increases. As a result, the PTC elements 2 can form a self-regulating heating element in the case of which a temperature which is prespecified by the operating point of the PTC elements 2 is produced. The operating point can lie, for example, between 120° C. and 300° C., preferably between 150° C. and 270° C. The operating point can be, for example, 250° C.

On account of the self-regulation of the PTC elements 2, the heating module 1 is insensitive to malfunctions. If, for example, an undesirably high current flows across the PTC elements 2, their resistance increases, so that the current intensity falls. As a result, excessive overheating of the heating module 1 can be prevented.

Each of the PTC elements 2 is a cuboidal panel. The PTC elements 2 bear, by way of a rectangular base surface, against the housing 3. The side lengths of the base surface are referred to as the length and width of the PTC elements 2 in the text which follows. Perpendicular to an outer side 3a of the housing 3, the PTC elements 2 have an extent which is referred to as the height in the text which follows. The height of the PTC elements 2 is less than their width and their length. Therefore, the PTC elements 2 are flat.

The height of a PTC element 2 can lie between 0.2 mm and 1.0 mm, preferably between 0.3 mm and 0.8 mm, and can be, for example, 0.5 mm. The width of a PTC element 2 can lie between 2.0 mm and 5.0 mm, preferably between 3.0 mm and 4.5 mm, and can be, for example, 3.8 mm. The length of a PTC element 2 can lie between 4.0 mm and 15.0 mm, preferably between 5.0 mm and 13 mm, and can be, for example, 7.0 mm.

The housing 3 contains a metal material. For example, the housing 3 can comprise aluminum. In one embodiment, the housing 3 consists of aluminum. Aluminum has a high thermal conductivity. Accordingly, the housing 3 can be rapidly heated by heat which is generated by the PTC elements 2.

The housing 3 is sleevelike. The housing 3 has an inner side 3b and the outer side 3a. In a cross section perpendicular to an axis of symmetry of the housing 3, the housing 3 has, on its inner side 3b, a round, in particular circular, surface. The housing 3 is hexagonal on its outer side 3a. In this case, the housing 3 has six surfaces 3c, on each of which a PTC element 2 is arranged.

Owing to the hexagonal shape, the outer side 3a of the housing 3 can be virtually completely covered by PTC elements 2. As a result, the housing 3 can be rapidly and uniformly heated.

The size of the surfaces 3c on the outer side 3a is matched to the extent of the PTC elements 2. In particular, the surfaces 3c can have a length and a width which are respectively slightly greater than the length and the width of the PTC elements 2.

The PTC elements 2 can bear against the housing 3 without formation of an air gap.

The clamping contact 4 has a ring 4a and arms 4b. The number of arms 4b of the clamping contact 4 corresponds to the number of PTC elements 2 of the heating module 1 in this case. The arms 4b run substantially perpendicularly to a plane in which the ring 4a is arranged. The arms 4b are tilted inward in relation to an axis of the clamping contact 4, so that the arms 4b are spread and the arms clamp in the PTC elements 2 when the clamping contact 4 is mounted onto the housing 3 and the PTC elements 2. Each of the arms 4b serves for clamping precisely one PTC element 2.

Since the PTC elements 2 are therefore mechanically fastened exclusively by the clamping between the housing 3 and the clamping contact 4, an adhesive for fastening said PTC elements can be dispensed with. Health hazards which could result from the use of the adhesive in the heating module can therefore be precluded.

Furthermore, the housing 3 and the clamping contact 4 can electrically contact-connect the PTC elements 2 and in the process act as electrodes. Therefore, further components for electrically contact-connecting the PTC elements 2 can be dispensed with. Here, the housing and the clamping contact 4 have the dual function of electrically contact-connecting and mechanically fastening the PTC elements 2.

Furthermore, the heating module 1 has a carrier element 5 on which the housing 3, the PTC elements 2 and the clamping contact 4 are arranged. The carrier element 5 comprises a non-conductive material, for example plastic. The carrier element 5 has an injection-molded element. The clamping contact 4 is incorporated into the injection-molded element. The arms 4b of the clamping contact 4 protrude out of a top side of the injection-molded element. On a bottom side of the injection-molded element, the ring 4a can terminate flush with the injection-molded element. Accordingly, electrical contact-connection can be made with the clamping contact 4 on the bottom side of the injection-molded element. For example, a positive potential can be applied to the clamping contact 4.

The carrier element 5 has a first opening 5a and a second opening 5b. The first opening 5a is designed for receiving a spring contact 6. The spring contact 6 is electrically connected to the housing 3. A potential can be applied to the housing 3 via the spring contact 6. For example, a ground potential can be applied to the housing 3.

The second opening 5b of the injection-molded element is designed for receiving a split closure 7. The split closure 7 can be arranged in the second opening 5b. The split closure 7 then contributes to clamping of the carrier element 5 to the housing 3.

The vaporization device, in which the heating module 1 can be used, can further have an actuation circuit or actuation electronics system. However, even malfunctions in the actuation electronics system do not lead to overheating of the heating module 1 since excessive heating of the PTC elements 2 is precluded on account of the self-regulation of the PTC elements 2. Therefore, the PTC elements 2 make a critical contribution to the safety of the vaporization device.

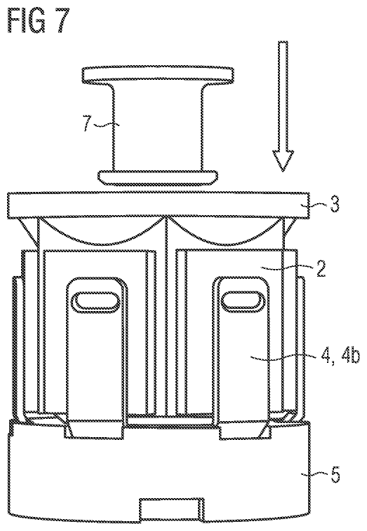

FIGS. 5 to 7 show the assembly of the heating module 1. In FIG. 5, the spring contact 6 is inserted into the first opening 5a of the carrier element 5. FIG. 6 shows the heating module 1 after the spring contact 6 has been inserted.

The housing 3 and the PTC elements 2 are then fitted. The housing 3 and the PTC elements 2 are jointly mounted onto the carrier element 5. In the process, the spring contact 6 is connected to the housing 3. Furthermore, clamping of the PTC elements 2 between the housing 3 and the clamping element 4 is effected in the process. FIG. 7 shows the heating module 1 after this step.

The split closure 7 is then inserted into the second opening 5b, as is indicated in FIG. 7. Owing to the splitting of the closure 7, it is possible to insert said closure into the second opening 5b. After the insertion of the closure 7 into the second opening 5b, the closure 7 clamps the housing 3 and the spring contact 6 to one another. Furthermore, the closure 7 increases the clamping force with which the PTC elements 2 are clamped in between the housing 3 and the arms 4b of the clamping contact 4.

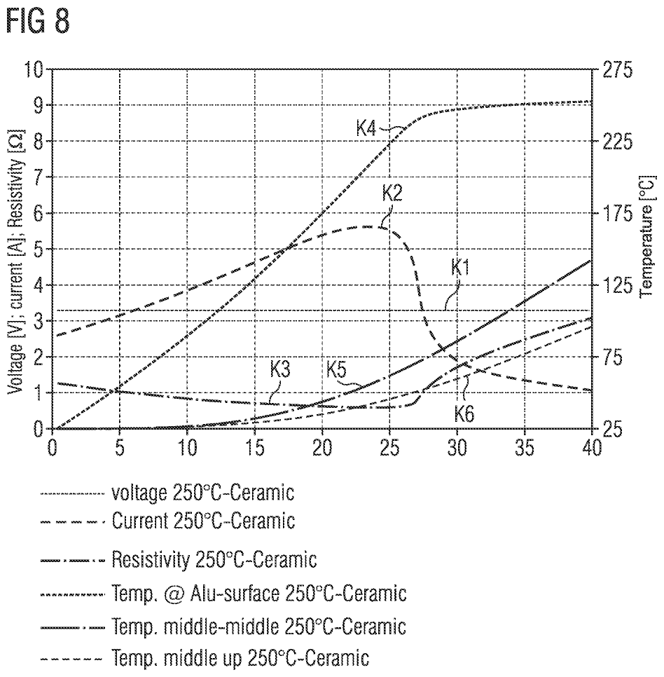

FIG. 8 shows the results of a simulation of the behavior of the heating module 1. The simulation was based on a PTC element 2 in which a surface temperature of 250° C. is established.

The curve K1 shows the profile of a voltage, which is applied to the PTC element 2, over the time period under consideration, which is 40 s here. The applied voltage remains constant at a value of between 3.4 and 3.6 V over the time. This value corresponds to a voltage which can be generated with a customary lithium-ion battery.

The curve K2 shows the profile of the current flowing across the PTC element 2. Said current initially rises. A maximum current intensity of 5.64 A is reached at approximately 25 s. The PTC element 2 is heated by the current flow, so that its resistance rises sharply. On account of the rise in the resistance, the current intensity drops. After an initially sharp drop in the current intensity, an approximately constant current intensity is established.

The curve K3 shows the resistance of the PTC element 2. Said resistance runs substantially inversely proportionally to the current intensity.

The curve K4 shows the temperature on the inner side 3b of the housing 3. It can be seen that there is initially a heating-up phase of approximately 25 seconds in which the temperature is continuously increased. After this heating-up phase, a virtually constant temperature which rises only slightly is established.

In the curves K5 and K6, the temperature is measured in various positions of a substance to be vaporized, which substance is arranged within the housing 3.

A response time, after which a temperature of 250° C. is reached on the inner surface of the housing 3, is 34 seconds.

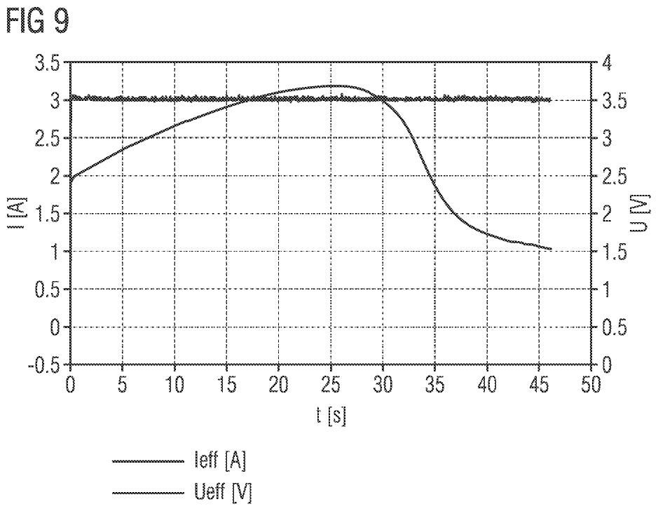

FIG. 9 shows the measurement results of a prototype of the heating module 1. In this case, six PTC elements 2, in the case of which a surface temperature of 205° C. is established given an applied voltage of 3.58 V, are used for the prototype. FIG. 9 shows the voltage which is applied to a PTC element and the current flowing across the PTC element 2. Said figure demonstrates the same behavior as in FIG. 8. The voltage remains constant over the entire time under consideration, the current initially rises and then drops and finally a virtually constant value is established. The maximum current intensity is 3.2 A. A current intensity of 1 A is established after 45 seconds. A temperature of 180° C. is reached 34 seconds after the device is switched on. The total resistance of the six PTC elements 2 which are connected in parallel is 1.56Ω.

1-15. (canceled)

16. A heating module comprising:
at least one positive temperature coefficient (PTC) element configured to operate at an operating point between 120° C. and 300° C. inclusive.

17. The heating module according to claim 16, wherein the PTC element comprises a ceramic material having a non-linear resistance profile.

18. The heating module according to claim 16, wherein the PTC element is a self-regulating heating element.

19. The heating module according to claim 16, wherein the PTC element is fastened by a clamping connection.

20. The heating module according to claim 16, further comprising:
a housing; and
a clamping contact,
wherein the PTC element is clamped in between the housing and the clamping contact.

21. The heating module according to claim 20, wherein the PTC element is heatable when a voltage is applied between the housing and the clamping contact.

22. The heating module according to claim 20, wherein no air gap exists between the housing and the PTC element.

23. The heating module according to claim 20, wherein the PTC element is arranged on an outer side of the housing.

24. The heating module according to claim 20, wherein the housing is sleevelike.

25. The heating module according to claim 24, wherein the housing has a hexagonal outer side.

26. The heating module according to claim 16, wherein the heating module has a plurality of PTC elements.

27. The heating module according to claim 26, further comprising:
a housing; and
a clamping contact,
wherein each of the PTC elements is clamped in between the housing and the clamping contact.

28. The heating module according to claim 27, wherein the clamping contact has a plurality of arms and each of the PTC elements is arranged between the housing and one of the arms of the clamping contact.

29. The heating module to claim 27, wherein the PTC elements are arranged symmetrically in relation to an axis of the housing.

30. The heating module according to claim 16, wherein the heating module has only one single PTC element, which is a cuboidal panel.

31. A vaporization device comprising:
the heating module according to claim 16; and
an actuation electronics system configured to apply a voltage to the PTC element.
